(19) United States
(12) Patent Application Publication
(10) Pub. No.: US 2007/0237092 A1
(43) Pub. Date: Oct. 11, 2007

(54) Method of establishing and maintaining distributed spectral awareness in a wireless communication system

(76) Inventors: Krishna Balachandran, Morganville, NJ (US); Joseph H. Kang, Belle Mead, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/229,896

(22) Filed: Sep. 19, 2005

(51) Int. Cl. H04L 12/28; H04L 12/56

(52) U.S. Cl. 370/254; 370/400

(57) ABSTRACT

In an ad hoc network in which nodes communicate directly with each other or through another node, hole exchange messages are transmitted on an ongoing basis from one node to one or more other nodes. The spectrum hole message transmitted by a node provides a current view of the frequency spectrum as seen by the transmitting node, indicating where in the spectrum holes exist that are available for transmission. Hole exchange messages are transmitted by a node in response to either time triggers or event triggers. The former includes transmitting a hole exchange message periodically, pseudo-periodically, or according to a timer expiry. The latter includes events such as the node discovering the presence of a new node, receiving a request from another node for the node's current view of the spectrum, upon bearer selection during call setup between the node and another node, degradation of the link between the node and another node, and upon bearer release between the node and another node.

### GOVERNMENT CONTRACT

This invention was made with Government support under Contract F30602-03-C-0079 awarded by DARPA. The Government has certain rights in this invention.

### TECHNICAL FIELD

The present invention relates to wireless communications.

### BACKGROUND OF THE INVENTION

There has been recent interest in the field of ad hoc networks, where nodes, whether static or mobile, communicate directly with one another rather than via a network element such as a base station or access point. The challenge with such ad hoc networks is that they operate typically in unlicensed spectrum bands where interference may be emanating from a variety of sources, each with potentially different characteristics. In traditional wireless networks such as cellular 2G and 3G networks, there is variation in the wireless channel due to fading and interference. In such traditional wireless networks, however, which typically operate in licensed spectrum and where base station locations can be selected, the deleterious effects of fading can be controlled by placing base stations in locations that meet link budgets. Furthermore, in such networks, interference can be managed using various mechanisms including frequency re-use, antenna orientation, and antenna arrays, among others. In stark contrast, ad hoc operation in unlicensed bands creates a far more variable and less predictable environment. Reliable communications achieved through mechanisms such as radio bearer assignment, which is relatively straight forward in cellular networks, become increasingly important and challenging in ad hoc networks where large, swift changes in channel conditions require the ability for nodes to monitor their local spectrum quality, share spectrum quality attributes with nodes that they plan to or are currently communicating, and dynamically form or change radio bearers based on spectrum information.

In cellular networks that operate with static allocations of spectrum, there are mechanisms to monitor and share spectrum quality, but they do not easily extend to the ad hoc domain. For instance, in 3G cellular networks, channel quality information is typically shared between a mobile terminal and a base station. The base station, thus has a view of spectrum quality experienced by different users and is well suited to make radio bearer assignments. The channel quality information reported by a mobile is, however, typically limited to the assigned frequency and a set of frequencies used in neighboring sectors (i.e., as indicated by a neighbor list). In ad hoc networks, radio bearer assignments typically will be negotiated on a pair-wise basis (e.g., between nodes that wish to communicate with each other), or on a group-wide basis (e.g., between nodes in a local area that wish to share multicast information such as control signaling for neighborhood maintenance). These negotiations, taking place at the time of call setup, require exchange of spectrum quality information between nodes, and can disadvantageously result in large delays in the call setup process.

### SUMMARY OF THE INVENTION

In an embodiment of the present invention, distributed spectrum quality information across a wide band of frequencies nodes is provided on an ongoing basis to a group of nodes in a local region, called a neighborhood, in the ad hoc wireless network. This distributed spectrum quality information enables these nodes to select reliable radio bearers in an expeditious manner during call setup between such nodes. By maintaining such a distributed view of how nearby nodes perceive spectrum quality, the delay in setting up a call between such nodes is advantageously less than the delay that would otherwise be encountered if spectrum quality information was exchanged between nodes only at the time of call setup. Furthermore, by providing distributed spectrum awareness, the nodes in the neighborhood are able to maintain a control channel for signaling that is dynamic due to the unpredictable nature of unlicensed spectrum. Thus, unlike cellular networks where control channels are carefully designed to accommodate worst-case interference and fading, in ad hoc networks, there are virtually no limits on interference, and control channels need to dynamically change in response to spectrum conditions.

By sharing spectrum views with one another on an ongoing basis and not just at call setup, a group of nodes within a neighborhood are able to avoid large delays that could be encountered in sharing spectrum information over what may be a large swath of the spectrum. For example, 80 MHz has been allocated to the unlicensed band at 2.4 GHz. In addition, under certain circumstances, pair wise communication between nodes may be avoided, where when the number of nodes, N, in a neighborhood is large, up to N!/(N−2)!2! bi-directional links may be required to share such spectrum information.

In accordance with an embodiment of the present invention, distributed spectral awareness amongst nodes in a neighborhood is achieved through the exchange of “hole exchange messages” between the neighborhood of nodes on an ongoing basis. Such hole exchange messages indicate to the recipient(s) nodes the regions of spectrum that are currently being under-utilized, i.e., spectral holes, as seen by the node that is transmitting the hole exchange message. Without loss of generality, a spectral hole is defined as a portion of the spectrum which is either known to have low utilization or is determined from measurements to be unutilized or under-utilized. Knowledge of where those spectral holes exist thus enables nodes that are desirous of establishing communication there between to expeditiously make bearer channel assignments at frequencies where such spectral holes are identified.

The embodiment of the present invention defines (a) how to exchange messages to create/maintain distributed spectral awareness within a neighborhood of nodes; (b) with which nodes to exchange messages to create/maintain distributed spectral awareness in the neighborhood of nodes; (c) where to exchange messages to create/maintain distributed spectral awareness in the neighborhood of nodes; (d) when to exchange messages to create/maintain distributed spectral awareness in the neighborhood of nodes; and (e) what to exchange (e.g. content of messages) to create and/or maintain distributed spectral awareness in the neighborhood of nodes.

### BRIEF DESCRIPTION OF THE DRAWING

FIG. 1 is a block diagram showing a neighborhood of nodes that might at some time be desirous of communicating with each other in either a one-to-one basis or one-to-many basis; and

FIG. 2 is a flowchart showing the framework for transmitting and receiving hole exchange messages among nodes in an ad hoc network in accordance with an exemplary embodiment of the present invention.

### DETAILED DESCRIPTION

Although the following description is described as based on a generic wireless communication network or system supporting ad hoc communication in unlicensed spectrum, and will be described in this exemplary context, it should be noted that the exemplary embodiments shown and described herein are meant to be illustrative only and not limiting in any way.

Additionally where used below, the term “node” may be considered synonymous with user equipment, terminal, mobile terminal, sensor node, subscriber, user, remote station, mobile station, access terminal, etc., and describes a remote user of wireless resources in a wireless communication network.

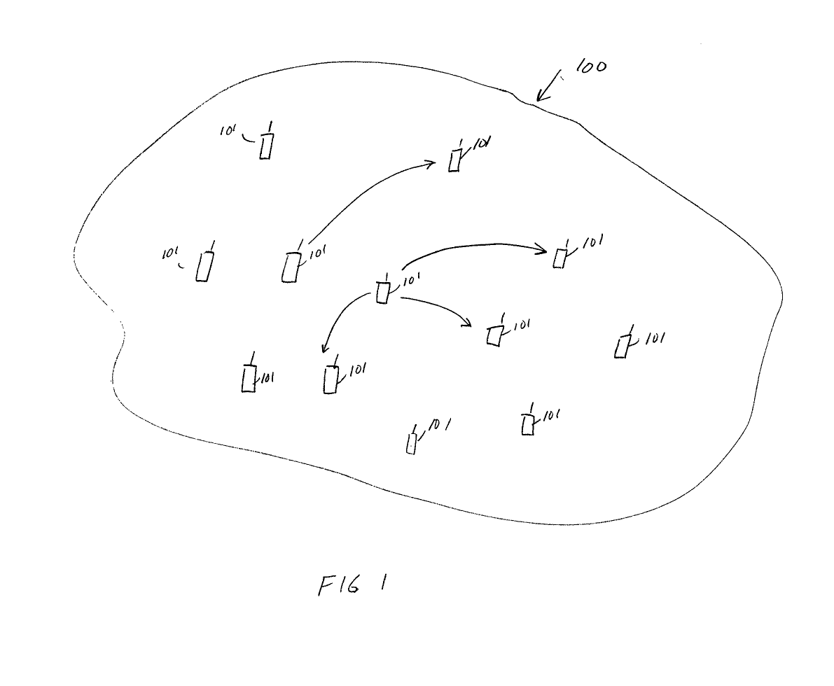

FIG. 1 is a block diagram of an ad hoc wireless communications system 100 in which a plurality of mobile nodes 101 are capable of communicating with each other. Each node 101 has a transmitter for transmitting messages to one or a plurality of the other terminals. Similarly, each node 101 has a receiver for receiving the messages sent to it by another node 101. Messages that are transmitted by a node 101 can be sent point-to-point (i.e., unicast) to another node within the transmitting node's communications range, can be sent to a targeted group of nodes (i.e., multicast within the transmitting node's communications range), or can be sent to all nodes within the transmitting node's communications range (i.e., broadcast). A message header may specify the message type (i.e., unicast, multicast or broadcast), and if unicast or multicast, the intended node or group recipient. Whereas all ad hoc messages are broadcast in nature, such that all nodes within communications range can attempt to decode the message, specification of the message type in the message header allows nodes to increase battery life by ignoring payloads of messages for which it is not an intended recipient. In addition, the payload may be encrypted.

In the illustrative embodiment of the present invention, spectral information is exchanged amongst nodes in a neighborhood of nodes on an ongoing basis through the transmission of hole exchange messages that indicate regions of spectrum that are currently under-utilized, i.e., where spectral holes exist. Such hole exchange messages may also include other information, as will be described in detail hereinafter. These hole exchange messages can be multicast or broadcast because the spectrum information being conveyed is of interest to all nodes within the neighborhood and within communications range, since each is a candidate for future communications as a source and/or destination node, or as an intermediary node through which packets can be routed. If security is required to prevent hostile jamming, for example, the hole exchange message may be multicast, as opposed to broadcast, or unicast, as opposed to multicast, and the payload may be encrypted.

The node destination to which a node 101 transmits a hole exchange message depends on the nature of the time/event that triggers the transmission of the message. When in a discovery state, (i.e., when a node is searching for the existence of other nearby nodes), hole exchange messages can be either multicast to targeted group members if connectivity with only a focused group is desired, or alternatively broadcast to any node in the area if any form of connectivity is required. When in initial negotiation and setup (i.e., when signaling after discovering another node), hole exchange messages can be transmitted either point-to-point to that discovered node or multicast to the neighborhood with which that discovered node is associated. When in a connected state (i.e., when connected to one or more nodes), hole exchange messages can be either unicast or multicast to those one or more nodes.

Hole exchange messages can be exchanged over logical or physical channels defined for control and/or bearer traffic. Control channels may be used for signaling between a group of nodes within a neighborhood. In such cases, distributed spectral awareness is achieved by having nodes multicast hole exchange messages over such control channels to all nodes in the neighborhood. In addition, hole exchange messages can be piggybacked onto data bearer channels so as to enable rapid exchange of information to support on-going communications.

Hole exchange messages can be transmitted between nodes according to either time or event triggers. With respect to time triggering, hole exchange messages can be transmitted: 1) periodically according to strict periodic intervals (i.e., every N time units); 2) pseudo-periodically (i.e., not strictly limited to transmission at time N, 2N, 3N, etc., but rather at times obeying a small grace period such as N±δ, 2N±δ, 3N±δ, etc.); or 3) according to timer expiry (i.e., set the timer to N; before timer expires, must send a message; after sending the message, reset timer), where the second and third methods allow additional flexibility for transmissions to occur in the dynamic ad hoc environment

With respect to event triggering, transmission of a hole exchange message can be triggered at a node: 1) upon the node discovering the presence of a new node in the neighborhood; 2) upon receiving a request from another node for a hole exchange message containing the node's current view of the spectrum; 3) upon bearer selection/negotiation during call setup between the node and another node; 4) upon the degradation below a threshold of the link between the node and another node; 5) upon bearer release between the node and another node; and 6) to fill empty bits at the tail-end of payload data (i.e., to avoid frame fill inefficiencies) transmitted by the node to another node.

As aforenoted, hole exchange messages indicate regions of spectrum that are under-utilized, i.e., where spectral holes exist from the standpoint of the node transmitting the message. In addition to sharing indications of quality in different portions of spectrum, general information indicating source/destination addresses, and channelization, among others, may also be included within a hole exchange message. In addition, a hole exchange message can be configured to require acknowledgement as to whether or not the message was received, the ability to indicate start and stop frequencies, the ability to use different methods of channel scoring, and aggregation of scores. In particular, the following indicates a superset of fields that may be included in the hole exchange message, where depending on the specific needs of the application in which it is being employed, different implementations may consist of subsets of these field. Furthermore, the specific content of the hole exchange message may be variable based on specific current bearer characteristics (e.g. less spectrum information may be transmitted if the supported data rate is low) and the nature of the hole exchange message trigger (e.g. trigger event). The fields of a hole exchange message may thus include:
1. the source address of the node transmitting the hole exchange message;
2. the destination address(es) of the message;
3. group identifier(s) of the source and/or destination;
4. message type (e.g. broadcast, multicast, or unicast);
5. timestamp for message;
6. an indicator specifying whether this message is a response to a previous message;
7. if this message is a response, then the response type (e.g., ACK/NACK, hole information request);
8. an indicator specifying whether acknowledgement to the message is required;
9. if a response is required, then the required response type with optional coded fields (e.g., ACK/NACK, request for hole information, parameters associated with hole information request, etc.);
10. the number of contiguous blocks of spectrum, N, for which spectral information is being conveyed;
11. for j=1 to N:
   a. channelization granularity employed in block j;
   b. the start frequency of block j;
   c. the end frequency of block j;
   d. the method of channel scoring (e.g., hard [i.e., 1 or 0] or soft; if soft, which method of soft)
   e. the parameters associated with channel scoring (e.g., number of soft scoring levels, thresholds used for hard/soft scoring, etc.); and
   f. for k=start frequency to end frequency (in steps of channelization granularity):
      i. timestamp indicating when score was last updated;
      ii. score for channel; and
      iii. nature of channel score (e.g. if score was aggregated based on neighbor scores received).

Different channelization granularities may be employed depending on the extent of the spectrum to be scored, spectrum sensing constraints, the needs of the application and the limitations on overhead. For example, 1 MHz of spectrum can be scored using a channelization granularity of 10 kHz which results in the reporting of 100 scores. Alternatively, a channelization granularity of 50 kHz may be employed thus reducing the size of the report to 20 scores but limiting the benefits achievable through distributed spectrum awareness.

Different scoring methods can be applied. At one extreme is hard (binary) scoring where a ‘1’ is used to report that a channel is presently occupied and a ‘0’ is used to report that a channel is available. At the other extreme is reporting of raw sensor data as is, with little or no processing. A range of soft scoring methods between these two extremes is possible where the sensor output is post-processed and the scores are quantized to the desired level of accuracy. The score may be in the form of a channel quality metric such as the interference level, bit-error probability or signal-to-interference-plus-noise ratio where instantaneous values, averages and/or the variance of these metrics may be employed in the scoring.

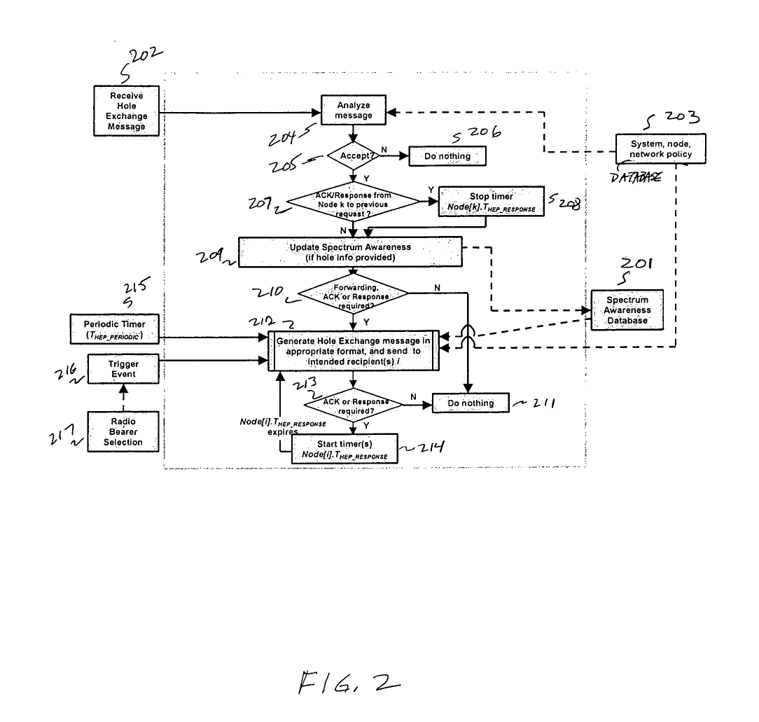

FIG. 2 illustrates an exemplary protocol framework at a particular node for receiving and transmitting hole exchange messages that can be used in order to achieve distributed spectrum awareness within a neighborhood of such nodes. At a particular node, prevailing spectrum quality data as determined by that node or as received from other nodes, such as channel scores, are stored locally at that node in a spectrum awareness database 201. Hole exchange messages transmitted by this node to other nodes, and the hole exchange messages transmitted by other nodes to this and other nodes in the neighborhood facilitate the sharing of stored data among the nodes in the neighborhood in order to derive a common (or synchronized) view of spectrum quality across the neighborhood.

With reference to FIG. 2, when a node, at step 202, receives a hole exchange message from another node, it analyzes the message to determine if it satisfies policies applicable to the spectrum, the node, or the network, where such policies are stored locally by the node in a database 203. As an exemplary embodiment, the node may not accept the message for further processing if the message is not designated for this node. In another exemplary embodiment, the node may not accept the message for further processing the policy limits operation of the node to a certain spectrum and the received message relates to frequencies that are outside the allowed spectrum. At step 204, the received message is analyzed. At step 205, a determination is made whether or not the message can be accepted based on the system, node, or network policy stored in database 203. If the message cannot be accepted, for example if it relates to a frequency outside the allowed spectrum, the message is not processed further (step 206). If the message is accepted, then, at step 207, a determination is made whether the received message is: an acknowledgment (ACK) from a node k to a hole exchange message previously sent to it from the present node; or a response to a previous request made by the present node for spectrum information from node k. If it is either an ACK to a hole exchange message sent by the present node, or a response to a previous request for spectrum information, then, at step 208, a timer, Node[k]. T_{HEP}_{_{—}}_{RESPONSE}, is stopped that had been started when the present node either sent a hole exchange message containing hole information to node k, or when it sent a hole exchange message containing a request to node k for spectrum information, respectively. (As will be noted below, if node k does not respond with a hole exchange message containing an ACK to a message sent to it by the present node [if an ACK was requested] or does not respond with a hole exchange message containing hole information in response to a request from the present node for spectrum information within the expiration of that time, another message or request, respectively is sent by the present node to node k). If the received hole exchange message contains hole information, then, at step 209, spectrum awareness is updated and stored in the present node's local spectrum awareness database 201.

After step 209, when spectrum awareness has been updated with the information contained in the received hole exchange message, or if the hole exchange message is a request for spectrum information, then, at step 210, a determination is made whether the present node must send a hole exchange message with an ACK or with spectrum information to node k. If neither an ACK nor a response is required, then, at step 211, the present node presently does nothing. If an ACK or a response is required, the present node, at step 212, generates a hole exchange message in an appropriate format and sends it to the intended recipient(s).

If an ACK is required, the generated hole exchange message is formatted as an ACK, and is sent to node k to acknowledge receipt of the hole exchange message from node k. If hole information is required, then a hole exchange message containing the present node's current spectrum view is transmitted to the requesting node k. Specifically, using the policy information stored locally in policy database 203 and the current prevailing spectrum view stored in spectrum awareness database 201, a hole exchange message is generated containing that information and is sent to the requesting node k. That prevailing spectrum view stored in the spectrum awareness database 201 can, for example, be channel scores, as previously described. If, at step 213, a determination is made that an ACK to that responsive hole exchange message is required by the present node, then, at step 214, the timer Node[k]. T_{HEP}_{_{—}}_{RESPONSE} is started so as to await receipt of an ACK from node k. If an ACK is received from node k before the timer expires, then, as aforedescribed, the timer is stopped at step 208. It the timer expires, however, before an ACK is received, then it is assumed that the message was not successfully received and, back at step 212, a hole exchange message containing the latest spectrum view is regenerated and retransmitted to node k.

The present node generates a hole exchange message containing spectrum information in response to a request for the present node's spectrum view from another node k as described above. A hole exchange message containing spectrum information may also be transmitted according to time or event triggers, as previously described. Thus, for time triggers, as described, a hole exchange message containing current spectrum information can be generated in response to the present node's periodic timer 215 (T_{HEP}_{_{—}}_{PERIODIC}). As previously described, that can occur periodically, pseudo-periodically, or according to timer expiry. An event 216 can also trigger the present node to generate and transmit hole exchange message(s) to other nodes. As was described, these events can include various bearer channel conditions (217) such as detection of interference on a link, bearer selection/negotiation during call setup, bearer release, or discovery of a new node. Prior to transmitting a hole exchange message containing spectrum information, a node may update its current view of spectral holes stored in database 201 according to the prevailing spectrum policies (stored in database 203) and/or its most recent channel measurements.

When, at step 212, a hole exchange message containing spectrum information is generated in response to a time or event, then, as described, a determination is made whether ACKs from the nodes to which the hole exchange message has been transmitted are required. If so, appropriate timers are started, and if an ACK is not received from a node by that node's timer's expiry, it is assumed that the hole exchange message was not successfully received and the hole exchange message is retransmitted to those nodes not receiving it.

A hole exchange message requesting node k to provide its current spectrum view to the present node can also be generated at step 212. In that case, a response from node k to that request is required at step 213 and the timer, Node[k]. T_{HEP}_{_{—}}_{RESPONSE}, is started. If a responsive hole exchange message is not received from node k by that timer's expiry, then the request is retransmitted. If the present node receives a responsive hole exchange message before the timer expires, as described, that timer is stopped at step 208.

Hole exchange message overhead can be reduced in cases where hole information tends to be temporally or spatially correlated using one or more of the following methods: (1) sequential hole exchange: information for a partial list of frequencies is transmitted at each hole exchange instant; distributed awareness is achieved across one or more frequency bands of interest by exchanging a sequence of hole exchange messages; and 2) staggered hole exchange: information for a partial list of frequencies is transmitted at each hole exchange instant just as in the case of sequential hole exchange; hole exchange instants, however, are staggered across users within a neighborhood so that (i.e., as far as possible, each user transmits hole information across a different part of the spectrum) distributed spectrum awareness is achieved quickly within the neighborhood.

While the particular invention has been described with reference to an illustrative exemplary embodiment, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Those skilled in the art will thus readily recognize that such various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

The invention claimed is:

1. In a network in which a plurality of nodes communicate directly with each other or through one or more other nodes over an operative frequency spectrum, a method at a first node comprising:
transmitting hole exchange messages on an ongoing basis, wherein each of at least some of the hole exchange messages provides a current view as seen by the first node of the frequency spectrum that indicates where the first node has determined spectral holes to exist.

2. The method of claim 1 wherein the current view of the frequency spectrum is stored by the first node in a local database.

3. The method of claim 1 wherein at some of the hole exchange messages are transmitted in response to time triggers.

4. The method of claim 3 wherein the at least some of the hole exchange messages are transmitted periodically.

5. The method of claim 3 wherein the at least some of the hole exchange messages are transmitted pseudo-periodically.

6. The method of claim 3 wherein the at least some of the hole exchange messages are transmitted according to a timer expiry.

7. The method of claim 1 wherein at least some of the hole exchange messages are transmitted in response to an event trigger.

8. The method of claim 7 wherein an event trigger includes: 1) the first node discovering the presence of a new node in the network; 2) the first node receiving a request from another node in the network that a hole exchange be transmitted to it containing the first node's view of the frequency spectrum; 3) upon bearer selection or negotiation during call setup between the first node and another node in the network; 4) upon degradation below a threshold of quality of a link between the first node and another node in the network; 5) upon bearer release between the first node and another node in the network; and 6) to fill empty bits at the tail-end of payload data transmitted by the first node to another node in the network.

9. The method of the claim 1 wherein at least one of the hole exchange messages is unicast by the first node to a specified other node in the network.

10. The method of claim 1 wherein at least one of the hole exchange message is multicast by the first node to a specified group of other nodes in the network.

11. The method of claim 1 wherein at least one of the hole exchange message is broadcast by the first node to all other nodes within communication range of the first node in the network.

12. The method of claim 1 wherein each of the at least one the hole exchange message includes a channel score for a specified number of channels within the frequency spectrum.

13. The method of claim 12 wherein the channel score is a hard score indicating whether each channel is occupied or available for transmission.

14. The method of claim 13 wherein the channel score is a soft score representing a multi-level channel quality metric.

15. The method of claim 1 wherein prior to transmitting at least some of the hole exchange messages, the node updates its current view of where spectral holes exist in the spectrum according to prevailing spectrum policies and/or measurements.

16. In a network in which a plurality of nodes communicate directly with each other or through one or more other nodes over an operative frequency spectrum, a method at a first node comprising:
receiving hole exchange messages on an ongoing basis from other nodes in the network, wherein each of at least some of the received hole exchange message provides a current view as seen by a transmitting other node of the operative frequency spectrum indicating where the transmitting node has determined spectral holes to exist, and
updating a current view of the frequency spectrum that is stored by the receiving node with information contained in the received hole exchange message.

17. The method of claim 16 wherein at least one of the hole exchange messages received from another node is received in response to a request transmitted by the first node to the other node for the other node's view of frequency spectrum that indicates where the other node has determined spectral holes to exist.

18. The method of claim 16 wherein the each of the at least one of the hole exchange messages includes a channel score for a specified number of channels within the frequency spectrum.

19. The method of claim 18 wherein the channel score is a hard score indicating whether each channel is occupied or available for transmission.

20. The method of claim 18 wherein the channel score is a soft score representing a multi-level channel quality metric.
